(19) United States
(12) Patent Application Publication
(10) Pub. No.: US 2025/0187281 A1
(43) Pub. Date: Jun. 12, 2025

(54) Method of Manufacturing a Micro-Optic

(71) Applicant: Printoptix GmbH, Stuttgart (DE)

(72) Inventors: Simon Thiele, Stuttgart (DE); Nils Fahrbach, Stuttgart (DE); Simon Hartlieb, Esslingen (DE); Michael Schmid, Metzingen (DE)

(21) Appl. No.: 18/970,191

(22) Filed: Dec. 5, 2024

(30) Foreign Application Priority Data
Dec. 6, 2023 (DE) 10 2023 134 117.0

(51) Int. Cl. B29D 11/00; B29K 505/00; B33Y 80/00

(52) U.S. Cl. CPC B29D 11/00365; B29K 2505/00; B33Y 80/00

(57) ABSTRACT

A method for manufacturing a micro-optics, including the steps of creating at least one optical component, creating a grid structure of a support structure at least partially surrounding the at least one optical component, filling the grid structure with a curable polymer, and curing the polymer in the grid structure to create the support structure.

### CROSS-REFERENCE TO RELATED APPLICATION

This application claims priority to German Patent Application No. 10 2023 134 117.0 filed Dec. 6, 2023, the disclosure of which is hereby incorporated by reference in its entirety.

### BACKGROUND OF THE INVENTION

### Field of the Invention

The present invention relates to a method for manufacturing a micro-optics and such a micro-optics.

With known micro-optics, it is necessary that the optical assemblies consisting of several optical elements are positioned at a defined distance and with a defined orientation to each other. For this purpose, it is known to provide solid retaining structures or support structures that surround the optical elements in the form of a sleeve. However, particularly if both the optical assemblies and the retaining structures are to be created by means of 3D laser writing, as is the case with monolithic micro-optics from prior art, the retaining structures in particular require a considerable amount of time. Furthermore, 3D laser writing takes place in the liquid phase, wherein a photoresist is cured at the location of the voxel, in particular by means of 2-photon polymerization. This means that after printing, despite the enclosing shell of the retaining structure, excess photoresist that has not cured during the writing process must flow out or be washed out of the spaces between the optical elements. Openings must therefore be provided, which make the design of the retaining structure complex and must always be adapted, in particular for different micro-optics.

### Description of Related Art

It is also desirable for the optical elements to be surrounded by a light-impermeable sleeve, which is to be integrated into the retaining structure in particular. EP 3 162 549 A1 describes a method in which gap-shaped cavities are provided in the area of the retaining structure, which are filled with an absorbent liquid after printing, which then cures. This results in a complex retaining structure, the creation and production of which is time-consuming and often results in restrictions regarding the positioning and number of optical elements that can be used.

### SUMMARY OF THE INVENTION

The object of the present invention is to provide a micro-optics with a retaining structure that is simpler and can be created more quickly.

The object is achieved with a method as described herein and a micro-optics as described herein.

The method according to the present invention for manufacturing a micro-optics comprises the following steps:
creating one or more optical components,
creating a grid structure of a support structure at least partially surrounding the one or more optical components,
filling the grid structure with a curable polymer, and
curing the polymer in the grid structure to create the support structure.

In particular, the one or more optical components, which are particularly configured to be solid, and the support structure can be created simultaneously in one step. The optical properties of the micro-optics can be provided by the optical components created to be solid. The surrounding support structure firmly arranges the one or more optical components at a defined distance and at a defined orientation to one another. The support structure can be written more quickly due to its grid structure, as no solid support structure is required. Rather, the support structure consists of the grid structure and the polymer cured in the grid structure. This can save a considerable amount of time. Due to forming the support structure by means of the grid structure, the photoresist required to create the grid structure and the optical components can easily flow out or be washed out of the internal cavities of the micro-optics. It is not necessary to provide additional openings in the support structure. The support structure can therefore be less complex and any necessary adaptation to different micro-optics is simplified.

Preferably, the support structure completely surrounds the one or more optical components, in particular in the form of a sleeve. The support structure thus defines a substantially cylindrical shape of the micro-optics.

Preferably, the optical elements are, for example, lenses, prisms, gratings, mirrors or the like. In particular, more than one optical component and preferably a plurality of optical components can be provided in the micro-optics.

Preferably, the grid structure is created by means of 3D laser writing and in particular by means of 2-photon laser writing. It has been shown that 3D laser writing can be used to create suitable structures on an appropriate scale with the accuracy required to create such a grid structure. In 3D laser writing, a photoresist is cured by a focused laser beam to create the desired structure. Thus, small structures can be formed precisely and the desired dimensions of the structure elements of the grid structure can be achieved. At the same time, the 3D laser writing method achieves a high level of reproducibility so that grid structures for micro-optics can be reliably created.

Preferably, the entire micro-optics, i.e. the grid structure together with the one or more optical elements, is created by means of 3D laser writing and in particular by means of 2-photon laser writing. In particular, this is done in one process, so that the grid structure and the one or more optical components are integrally formed or materially bonded, respectively.

Preferably, the grid structure is created from a transparent material. The transparent material is in particular an acrylate, an epoxy or a glass. Here, transparent refers to a property of the material to substantially transmit light in the near UV, the visible wavelength range and/or the near infrared. Here, substantially means that more than 50% of the light passes the material, preferably more than 70%, more preferably more than 90% and particularly preferred more than 95%.

Preferably, the grid structure and the one or more optical elements are integrally formed and preferably monolithically. In particular, the entire micro-optics is integrally or monolithically formed, respectively. In particular, the grid structure and the one or more optical elements can be made of the same material.

Preferably, the density of one of the optical components and in particular of all the optical components provided is higher than the density of the grid structure. Since the optical components are configured as solid components, their density is substantially the same as the general density of the cured photoresist, which is used to create the optical components and/or the grid structure. The grid structure, on the other hand, is not a solid component, so its density is lower. In particular due to the reduced density of the grid structure, it can be written more quickly.

Preferably, the fill factor of the grid structure is less than 0.5, in particular less than 0.3 and preferably less than 0.2 and particularly preferred less than 0.1. Here, the fill factor refers to the proportion of the total volume that is occupied by the structural elements of the grid structure. For example, with a fill factor of 0.5, half of the volume of the grid structure is occupied by the structural elements, in particular those formed from the photoresist, whereas the second half of the grid structure is empty/can be filled/is filled with the curable polymer.

Preferably, the grid structure comprises a plurality of interconnected open pores or unit cells. Microcavities, vacancies or cavities are created by the pores or unit cells. The interconnected open pores or unit cells can receive the curable polymer, which is then cured in the grid structure to create the support structure. Because the unit cells/pores are open and interconnected, the curable polymer introduced can easily penetrate the grid structure and then be cured. In particular, the grid structure can be formed regularly, for example from unit cells, or stochastically, for example by providing open pores. In particular, the size of the pores, the shape of the pores and their arrangement can be determined stochastically.

Preferably, the grid structure comprises a uniform unit cell or pore geometry, respectively. Thus, the entire grid structure of the support structure will have a uniform or almost uniform grid structure, which continues over the entire support structure. Alternatively, the unit cell or pore geometry can be changed, particularly along an axis of the micro-optics. By adjusting the unit cell or pore geometry within the grid structure, the flow behavior of the curable polymer can be influenced so that the grid structure can be filled evenly to create the support structure. The rigidity of the support structure can also be adapted, in particular increased, in one or more directions by adapting the grid structure.

Preferably, a wall thickness of the grid structure and in particular a strut of the grid structure as a structural element is between 0.5 μm and 50 μm and in particular between 0.5 μm and 10 μm. Such structure sizes can be written particularly quickly due to their small volume. As a result, the small size of the wall thicknesses or structural elements of the grid structure can significantly reduce the time required to create the grid structure.

Preferably, the wall thickness and/or a strut and/or another structural element of the grid structure corresponds to a voxel of the 3D laser writing. This means that in the 3D laser writing process, a structural element only has to be moved once over the corresponding structural element of the grid structure by the laser of the 3D laser writing device to create the respective unit cell or pore, respectively.

Preferably, the pore size or a size of the unit cell is between 20 μm and 1500 μm and in particular between 100 μm and 1000 μm. This means that individual pores or unit cells can be placed at a large distance from each other, further reducing the time required to create the support structure.

Preferably, the unit cells or pores of the grid structure are arranged Cartesian and alternatively, in particular if the micro-optics has a cylindrical shape, for example, the unit cells or pores of the grid structure can be arranged radially about the central axis of the micro-optics.

Preferably, the curable polymer is substantially non-transparent. Here, non-transparent refers to a property of the material not to substantially transmit light in the near UV, the visible wavelength range and/or the near infrared, but to absorb or reflect it. Here, substantially means that less than 50% of the light passes the material, preferably less than 20%, more preferably less than 10% and particularly preferred less than 5%. Thus, the filled curable polymer can also be used as a light-impermeable sleeve. The curable polymer is therefore part of the support structure together with the grid structure on the one hand, and on the other hand it also serves as protection against laterally penetrating stray light to improve the imaging properties of the micro-optics.

Preferably, the curable polymer is UV-curable by illumination with UV light, heat-curable by application of heat, curable by means of an initiator, in particular in the form of a two-component polymer, or curable by drying.

Preferably, the unit cells or pores are arranged nested with/within one another or offset with respect to one another.

Preferably, the unit cells or pores are configured to be cubic, circular, rounded or polyhedral. In particular, the unit cells or pores can take any shape that on the one hand provides sufficient stability of the grid structure for filling with curable polymer and on the other hand has a low density, so that the grid structure can be created particularly quickly, in particular by means of 3D laser writing. For example, the grid structure can also be sponge-shaped or configured as a gyroid.

Preferably, at least one side of one of the unit cells or pores is configured as a closed surface. In particular, the closed surface is arranged in the direction of light propagation or perpendicular thereto. As this creates a plurality of interfaces within the support structure, it is difficult or impossible for light to propagate in this direction, so that the support structure also provides a light-shielding function.

Preferably, metal particles or other functional materials are filled into the grid structure before being filled with the curable polymer. This allows additional functions to be provided for the retaining structure on the one hand and the micro-optics themselves on the other. Alternatively, the curable polymer contains metal particles, wherein the metal particles can in particular provide the opacity of the curable polymer.

Preferably, photoresist, which is required in the 3D laser writing process, is washed out of internal cavities of the micro-optics in a step before filling the grid structure with the curable polymer. In particular, the photoresist can be washed out through the open pores or unit cells of the grid structure without the need for further openings in the support structure.

In a further aspect, a micro-optics comprising at least one optical element and in particular a plurality of optical elements is provided, wherein the micro-optics is manufactured according to a method as described above.

### BRIEF DESCRIPTION OF THE DRAWINGS

The terms Fig., Figs., Figure, and Figures are used interchangeably to refer to the corresponding figures in the drawings.

In the following, the invention is described in more detail by means of preferred embodiments with reference to the accompanying figures.

The Figures show:

FIGS. 1A-1C show a schematic sequence of the method according to the present invention,

FIGS. 2A, 2B show a schematic sectional view of the micro-optics according to the present invention at different stages of manufacture,

FIGS. 3A-3H show different examples of the grid structure,

FIGS. 4A-4C show a detailed view of different grid structures according to the present invention, and

FIG. 5 shows a flow chart for the method according to the present invention.

### DESCRIPTION OF THE INVENTION

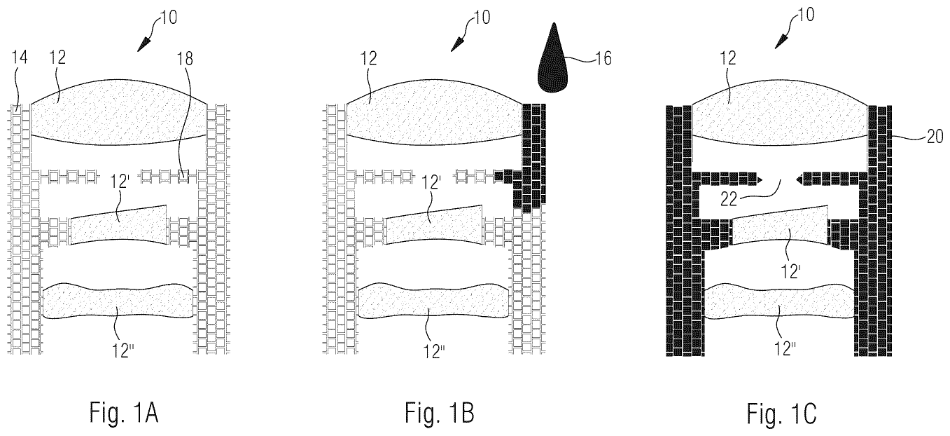

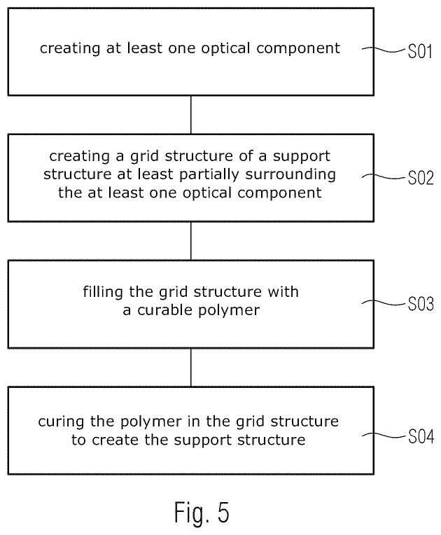

In the following, reference is made to FIG. 1 and FIG. 5. In the method according to the invention, at least one optical component 12, 12′, 12″ is created in step S01. The optical component is particularly formed to be solid. In FIGS. 1A-1C, the micro-optics 10 comprises three optical components 12, 12′, 12″, which are shown by way of example as lens 12, prism 12′ and free-form element 12″. The present invention is of course not limited to the optical components shown. Additional optical components, other optical components or even fewer optical components may be provided in the micro-optics 10 within the scope of the present invention. Simultaneously with creating the at least one optical component 12 or subsequently, a grid structure 14 at least partially and in particular completely surrounding the optical component 12 is created in step S02. The grid structure surrounds the optical components 12, in particular in the form of a sleeve, and fixes the optical components 12, 12′ and 12″ in their position and orientation relative to one another. The grid structure 14 comprises a plurality of open pores or unit cells that are connected to each other. Microcavities, vacancies or cavities are created by the pores or unit cells. The arrangement of the pores or unit cells can be regular in the grid structure 14 or configured to be stochastic. The size of the pores or the size of the unit cells is shown greatly enlarged in the figures. In particular, the grid structure 14 has a pore size or a unit cell size of between 20 μm and 1500 μm and in particular between 100 μm and 1000 μm.

Furthermore, the pores or the unit cells have wall thicknesses or structural elements such as supporting struts, connecting struts or the like with a size of between 0.5 μm and 50 μm and in particular between 0.5 μm and 10 μm. In particular, the size of the wall thickness of the grid structure 14 or the structural elements of the grid structure 14 corresponds to the voxel of the 3D laser writing process. Thus, during the 3D laser writing process, the laser for curing the photoresist only has to be moved once over the respective structural element of the grid structure 14 to completely form the wall or the structural element of the grid structure 14. Subsequently, in an optional step, photoresist can be washed out of the cavities between the optical elements 12, 12′ and 12″ and the grid structure 14. For this purpose, it is not necessary for the support structure 20 to have openings that need to be included. Rather, the photoresist can be guided out through the open pores or unit cells of the grid structure 14.

Subsequently, the grid structure 14 is filled with a curable polymer 16 in step S03. Here, filling can be facilitated, for example, by the capillary effect, which is generated by the small structural sizes of the pores or unit cells within the grid structure 14 and the surface energy of the liquid material used. FIG. 1B shows the partial filling in the grid structure 14. FIG. 1C shows the entire grid structure 14 filled with the curable polymer 16. In the subsequent step S04, the curable polymer is cured in the grid structure 14 and thus forms the support structure 20. The curable polymer 16 can be non-transparent and thus, in addition to its supporting function, simultaneously surround the optical components 12, 12′, 12″ as a non-transparent sleeve. Furthermore, FIGS. 1A-1C show that the grid structure 14 extends between the lens 12 and the prism 12′ in a radial direction. This radial extension of the grid structure 14 is also filled by the light-impermeable, curable polymer 16 and forms an aperture 22 after curing. Thus, it is not required to additionally provide channels or cavities within the support structure 20 to form apertures using a non-transparent polymer. The structure is simplified. Channels within the support structure 20 for conducting the curable polymer 16 need not be provided in the design, but are provided by the plurality of interconnected open pores or unit cells.

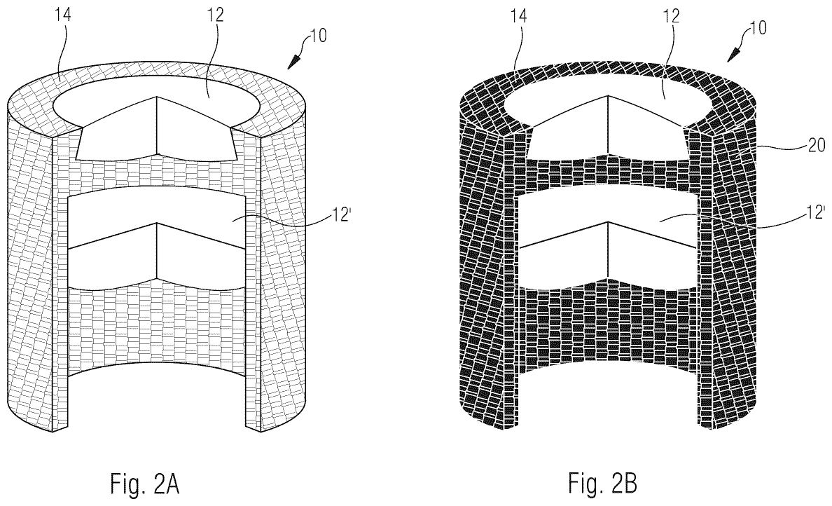

FIGS. 2A, 2B show a sectional view of a micro-optics according to the present invention. There, the solid optical components 12, 12′ can be seen, which are separated from each other by a cavity. Components 12, 12′ are completely surrounded by the grid structure 14. After the grid structure 14 has been created, it is filled with the curable polymer 16 and the curable polymer is cured. Curing can take place, for example, by drying, heat, UV or the curable polymer can be configured as a 2-component polymer having an activator, so that the curable polymer is cured by the activator.

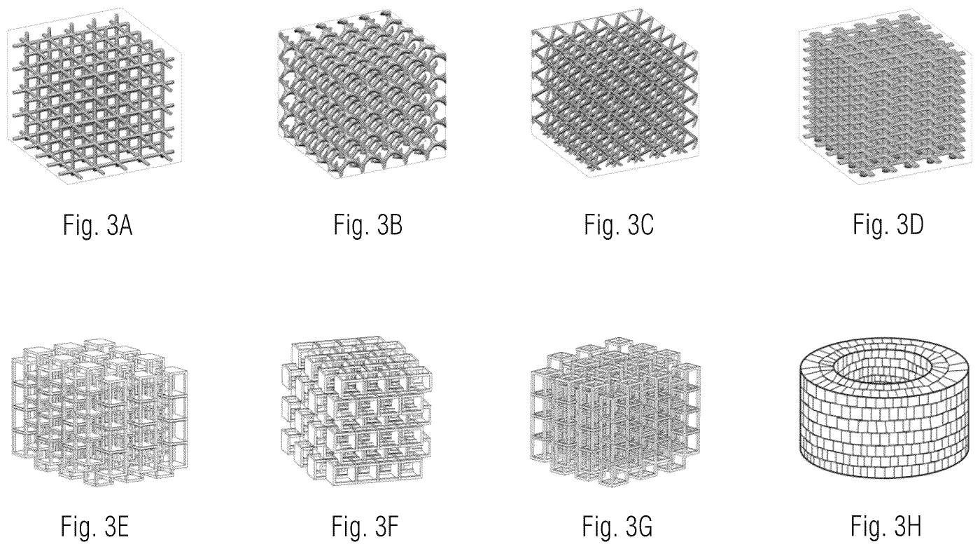

In the following, reference is made to FIGS. 3A-3H, which show examples of the grid structure 14 or parts of the grid structure. In particular, the parts of FIGS. 3A-3G have edge lengths of between 20 μm and 100 μm, in particular between 20 μm and 50 μm. For example, the unit cells can be arranged regularly and, in particular, can be nested with one another, as shown in FIGS. 3E-3G. Furthermore, the unit cells can be cubic, as shown in FIGS. 3A, 3D-3G, round as in FIG. 3B or tetrahedral as in FIG. 3C. Other forms of the unit cell can also be provided. In particular, the grid structure has a low volume fill factor. This can reduce the writing time for creating the grid structure 14 and at the same time reduce the amount of material required, which can save costs. Furthermore, the grid structure can be created as a special grid, for example as a gyroid in FIG. 3B.

While in FIGS. 3A-3G the unit cells or pores are arranged Cartesian, FIG. 3H schematically shows that the unit cells/pores can also be arranged radially and in particular can be arranged radially about a central axis of the micro-optics, which may coincide with the optical axis of the micro-optics.

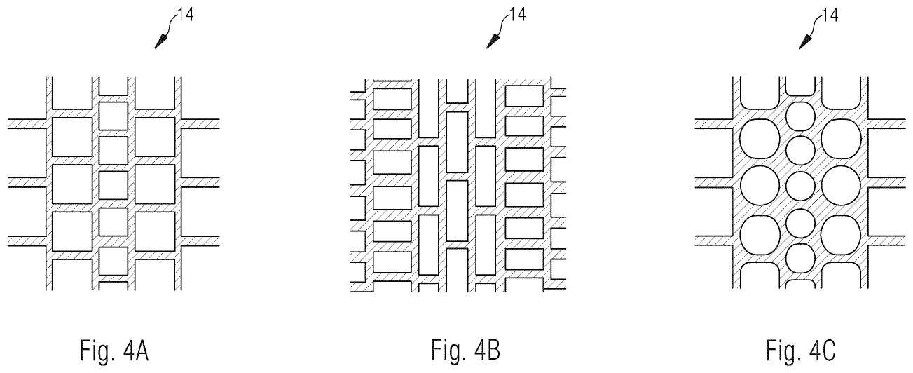

In the following, reference is made to FIGS. 4A-4C, which show a greatly simplified illustration of the unit cells or pores reduced to the plane. Here, FIGS. 4A to 4C show that different unit cells can be used to adapt the geometric configuration of the grid structure 14. On the one hand, this can influence the flow properties of the curing polymer 16 to be filled in. At the same time, the stability of the support structure can be reinforced in individual directions. FIG. 4A shows that the unit cell is square, FIG. 4B shows that the unit cell is rectangular and FIG. 4C shows that the unit cells are round or rounded.

Although FIGS. 3A-3H and 4A-4C show specific examples of the unit cells or pores of the grid structure 14, the present invention is not limited to a specific shape of the unit cells and pores of the grid structure 14, but the present invention encompasses a wide range of possibilities for the configuration of the specific grid structure 14. In particular, these grid structures 14 have open pores or unit cells for transferring the curable polymer 16 to be filled in, as well as a low fill factor. In particular, the fill factor is less than 0.5, preferably less than 0.2 and particularly preferred less than 0.1.

Thus, a micro-optics having a versatile support structure is provided, wherein the support structure can be created particularly quickly and comprises a grid structure and a filled-in curable polymer. It is not necessary to provide special channels and openings for washing out the photoresist, which is required to create the optical components or the grid structure, respectively. Likewise, no channels or openings need to be provided to accommodate the curable polymer. Both functions are provided by the grid structure 14. It is therefore also not necessary to adapt the support structure when changing the micro-optics, so that the support structure can be designed particularly simply, which can save further costs.

1. A method for manufacturing a micro-optics, comprising the steps of:
creating one or more optical components,
creating a grid structure of a support structure at least partially surrounding the one or more optical components,
filling the grid structure with a curable polymer, and
curing the polymer in the grid structure to create the support structure.

2. The method according to claim 1, wherein the grid structure is created by means of 3D lase writing.

3. The method according to claim 1, wherein the grid structure comprises a plurality of interconnected open pores or unit cells.

4. The method according to claim 1, wherein the grid structure is formed to be regular or stochastic.

5. The method according to claim 1, wherein the grid structure has a uniform unit cell or pore geometry or has a unit cell or pore geometry which varies in particular along an axis of the micro-optics.

6. The method according to claim 1, wherein a wall thickness of the grid structure is between 0.5 μm and 50 μm and in particular between 0.5 μm and 10 μm.

7. The method according to claim 1, wherein the grid structure has a fill factor of less than 0.5, in particular less than 0.3, preferably less than 0.2 and particularly preferably less than 0.1.

8. The method according to claim 1, wherein a wall thickness of the grid structure corresponds to a voxel of the 3D laser writing.

9. The method according to claim 1, wherein a pore size or a size of the unit cell corresponds to between 20 μm and 1500 μm and in particular between 100 μm and 1000 μm.

10. The method according to claim 1, wherein the unit cells or pores of the grid structure are arranged Cartesian or radially.

11. The method according to claim 1, wherein the curable polymer is substantially intransparent.

12. The method according to claim 1, wherein the support structure radially surrounds the at least one optical element and extends in the axial direction.

13. The method according to claim 1, wherein the support structure extends radially to form an aperture.

14. The method according to claim 1, wherein the unit cells are arranged nested within one another or offset with respect to one another.

15. The method according to claim 1, wherein the unit cells or pores are cubic, circular, rounded or polyhedral.

16. The method according to claim 1, wherein metal particles are filled into the grid structure before being filled with the curable polymer or the curable polymer contains metal particles.

17. A micro-optics comprising at least one optical element, wherein the micro-optics is created by the method according to claim 1.
